(19) United States
(12) Patent Application Publication
(10) Pub. No.: US 2011/0279927 A1
(43) Pub. Date: Nov. 17, 2011

(54) LOCKED WARNING APPARATUS USED FOR HANDLE OF HARD DISK DRIVE BRACKET

(75) Inventor: Cheng-hsien Lee, Xizhi City (TW)

(73) Assignee: QNAP SYSTEMS, INC., Xizhi City (TW)

(21) Appl. No.: 12/870,770

(22) Filed: Aug. 27, 2010

(30) Foreign Application Priority Data
May 14, 2010 (TW) 099209147

(51) Int. Cl. G11B 23/03

(52) U.S. Cl. 360/133; G9B/23.02

(57) ABSTRACT

A locked warning apparatus used for a handle of a hard disk drive bracket is described. The locked warning apparatus includes a locking base, a locking device, an upper cover assembly, and a pressing unit. The locking base has a clasping portion and an elastic protrusion. The locking device has a blocking portion. The clasping portion of the locking base is fastened to the locking device in a form of line-surface interface contact. The blocking portion reciprocates a back and forth motion on the elastic protrusion of the locking base to allow the locking device to retain either a lock status or an unlock status correspondingly. When the locking device retains the lock status, the locking device buckles the upper cover assembly. When the locking device retains the unlock status, the upper cover assembly can be ejected from the locking base by pushing the pressing unit.

### FIELD OF THE INVENTION

The present invention relates to a warning apparatus, and more particularly to a locked warning apparatus which is applicable to a handle of a hard disk drive bracket wherein a lock device simply reciprocates a back and forth motion on the locking base to improve the complicated conventional lock and key set for reducing the manufacturing cost of the warning apparatus.

### BACKGROUND OF THE INVENTION

Currently, because the computer system must process a large amount of data, a hard disk drive having large capacity and portable feature is a better choice to serve as storage media for a user. Besides the consideration of memory capacity, an assembly convenience and data usage reliability of the hard disk drive bracket positioned in the storage server or the machine case of a computer host need to be considered. Therefore, many hard disk drive bracket manufacturers desire to provide a hard disk drive bracket architecture with an easy assembly and data usage reliability.

Conventionally, a portable hard disk is disposed in the hard disk drive bracket and the hard disk drive bracket is then installed in the machine case wherein the hard disk drive is electrically connected to a connector in the machine case. When the user desires to get the hard disk drive, it is necessary to remove the hard disk drive bracket together with the hard disk drive from the machine case. However, if the hard disk drive in the hard disk drive bracket is in use (i.e. accessing data reading/writing), an unauthorized person may intentionally pull the handle of the hard disk drive bracket and suddenly remove the hard disk drive to stop the operation between the hard disk drive and the computer host, resulting in damaging of the hard disk drive or data lost during the access procedure. Therefore, a metal lock and key set is used in the prior art to lock the handle of the hard disk drive or to fasten the hard disk drive bracket in the machine case. More importantly, the aforementioned situation will increase the manufacturing cost, and it is very inconvenient to release the lock by the key. Further, if the key is lost and the user cannot immediately find the corresponding key to the lock, the users cannot remove the hard disk drive bracket. Consequently, there is a need to develop a novel warning apparatus to solve the aforementioned problems.

### SUMMARY OF THE INVENTION

The first objective of the present invention is to provide a locked warning apparatus which is installed with the handle of the hard disk drive bracket for preventing the operating hard disk drive from being accessed by the unauthorized person.

The second objective of the present invention is to provide a locked warning apparatus having a simplified lock and the warning apparatus replaces the conventional metal lock and key set. That is, the locking device has the feature of reciprocating a back and forth motion to improve the conventional lock and key set to omit the use of an additional unlock tool for reducing the manufacturing cost.

According to the above objectives, the present invention sets forth the locked warning apparatus. The locked warning apparatus includes a locking base, a locking device, an upper cover assembly, and a pressing unit. The locked warning apparatus is utilized in a handle of hard disk drive bracket. The locking base has a clasping portion and an elastic protrusion. The locking device has a first buckling unit and a blocking portion. When the locking device moves on the lock base, the clasping portion of the locking base is fastened to the locking device in a form of line-surface interface contact for reducing the friction force between the locking base and the locking device. The blocking portion reciprocates a back and forth motion on the elastic protrusion of the locking base to allow the locking device to retain either a lock status or an unlock status correspondingly. In one embodiment, the locking base utilizes clasping portions in the left and right sides for buckling the locking device to the locking base for stably sliding the locking device.

The upper cover assembly is pivotally connected to the locking base and has a first buckling hole and a second buckling hole wherein the first buckling unit is fastened to the first buckling hole of the upper cover assembly when the locking device retains the lock status. The pressing unit is pivotally connected to the locking base and has a second buckling unit. The second buckling unit is fastened to the second buckling hole of the upper cover assembly, and the second buckling unit is disengaged from the second buckling hole by pushing the pressing unit and by the force of the spring for ejecting the upper cover assembly from the locking base when the locking device retains the unlock status.

The locked warning apparatus utilizes the locking device reciprocates a back and forth motion (i.e. upward and downward) on the locking base so that the locking device and the pressing unit is capable of either buckling the upper cover assembly to the locking base or ejecting the upper cover assembly from the locking base. In one case, when the upper cover assembly retains the lock status by impelling upward the locking device, the upper cover assembly 106 does not pop up even if the user pushes the pressing unit. In the other case, when the upper cover assembly retains the unlock (released) status by impelling downward the locking device, the upper cover assembly pops up by the force of the spring after the user pushes the pressing unit.

The locked warning apparatus in the present invention can warn against or prohibit the unauthorized users from removing the hard disk drive bracket to avoid the damage of the hard disk drive or data lost during the access procedure of the hard disk drive. The locked warning apparatus replaces the conventional set of lock and key to solve the problem key lost when the user cannot find the key to unlock the lock.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is a schematic three-dimensional view of a locked warning apparatus according to one embodiment of the present invention;

FIG. 1B is a partially schematic three-dimensional view of the locked warning apparatus which is disposed within the machine case according to one embodiment of the present invention;

FIG. 2 is an exploded schematic three-dimensional view of the locked warning apparatus according to one embodiment of the present invention;

FIGS. 3A-3B are schematic views of the locking base of the locked warning apparatus according to one embodiment of the present invention;

FIGS. 4A-4B are schematic views of the locking device of the locked warning apparatus according to one embodiment of the present invention;

FIG. 5 is a schematic view of the upper cover assembly of the locked warning apparatus according to one embodiment of the present invention;

FIG. 6 is a partially schematic cross-sectional view of the locked warning apparatus retaining a lock status according to one embodiment of the present invention;

FIG. 7 is a partially schematic cross-sectional view of the locked warning apparatus retaining an unlock status according to one embodiment of the present invention;

FIGS. 8A-8C are partially schematic cross-sectional views of the upper cover assembly disengaging from the pressing unit by pushing the pressing unit for ejecting the upper cover assembly from the locking base according to one embodiment of the present invention; and

FIG. 9 is partially schematic cross-sectional view of the locking device retaining the lock status while the upper cover assembly is ejected from the locking base according to one embodiment of the present invention.

### DETAILED DESCRIPTION OF THE PREFERRED EMBODIMENTS

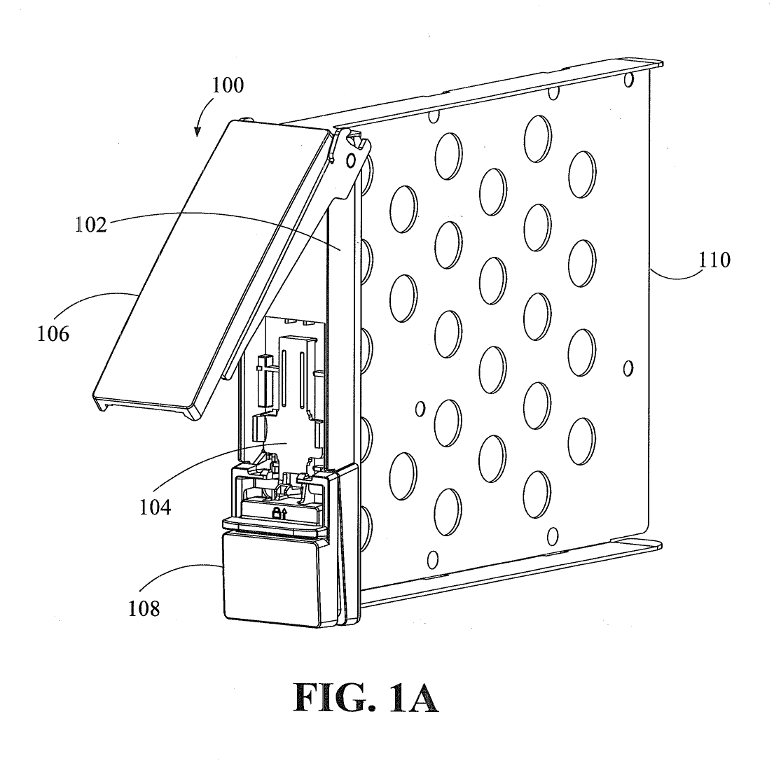

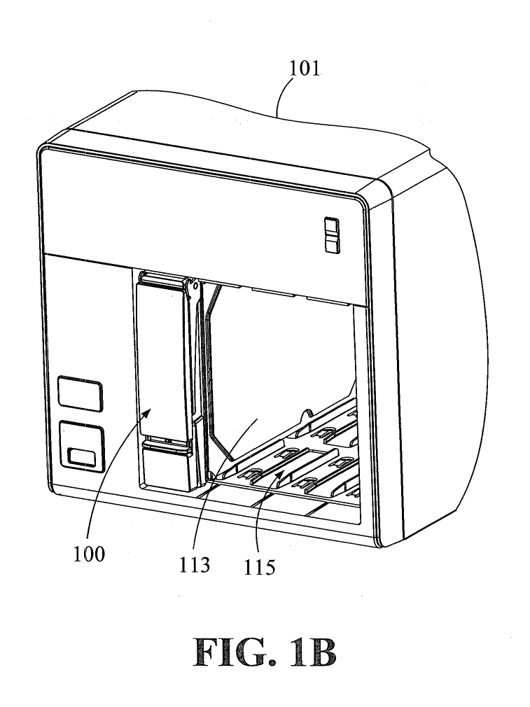

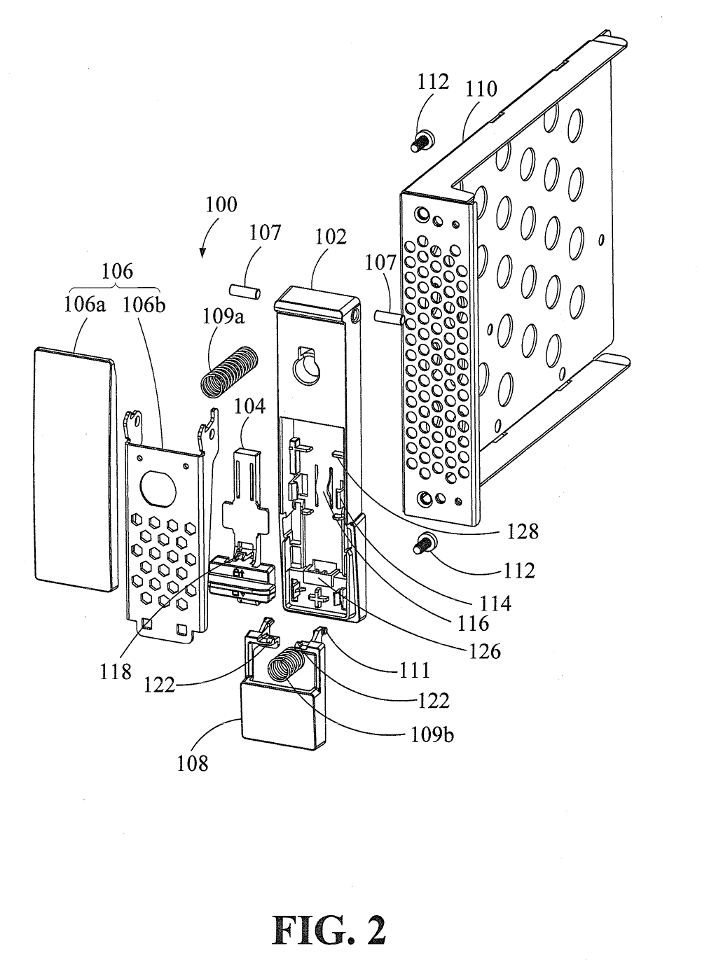

Please refer to FIGS. 1A-1B and FIG. 2. FIG. 1A is a schematic three-dimensional view of a locked warning apparatus according to one embodiment of the present invention. FIG. 1B is a partially schematic three-dimensional view of the locked warning apparatus which is disposed within the machine case according to one embodiment of the present invention. FIG. 2 is an exploded schematic three-dimensional view of the locked warning apparatus according to one embodiment of the present invention. The locked warning apparatus 100 includes a locking base 102, a locking device 104, an upper cover assembly 106, and a pressing unit 108. The locked warning apparatus is utilized in a handle of hard disk drive bracket. The locking base 102 can contain the locking device 104. One side end of the upper cover assembly 106 is elastically and pivotally connected to one side end of the locking base 102. For example, the upper cover assembly 106 employs two bolts 107 to be pivoted on the locking base 102 and a spring 109a is used to connect the upper cover assembly 106 and the locking base 102 so that the upper cover assembly 106 buckled on the locking base 102 is selectively capable of ejecting from the locking base 102. The pressing unit 108 is elastically and pivotally connected to another side end of the locking base 102. For example, the pressing unit 108 employs a pivot portion 111 to be pivoted on the locking base 102 and another spring 109b connects the pressing unit 108 to the locking base 102 so that the pressing unit 108 selectively is buckled on the upper cover assembly 106. The upper cover assembly 106 is composed the upper cover plate 106a and the upper frame 106b wherein the upper cover plate 106a is combined with the upper frame 106b.

In one embodiment of the present invention, the locked warning apparatus 100 is secured to the hard disk drive case 110 by the screw 112 wherein the upper cover assembly 106 serves as a handle of the hard disk drive case 110. For example, the locked warning apparatus 100 is disposed in the hard disk drive case 110 which is installed with a hard disk drive 113. The hard disk drive case 110 having the hard disk drive 113 is then inserted into the rack 115 of the machine case 101 so that the computer system and/or storage server can access (i.e. read and/or write) the data content stored in the hard disk drive 113. When the upper cover assembly 106 of the locked warning apparatus 100 is buckled on the locking base 102, i.e. the upper cover assembly 106 is closed, the locking device 104 is capable of locking the upper cover assembly 106 for preventing the hard disk drive 113 from damage during the data access. When the upper cover assembly 106 of the locked warning apparatus 100 ejects from the locking base 102, i.e. the upper cover assembly 106 is open, the upper cover assembly 106 serves as the handle of the hard disk drive case 110 for conveniently removing the hard disk drive case 110 from the rack 115 of the machine case 101 after the hard disk drive 113 stops operating.

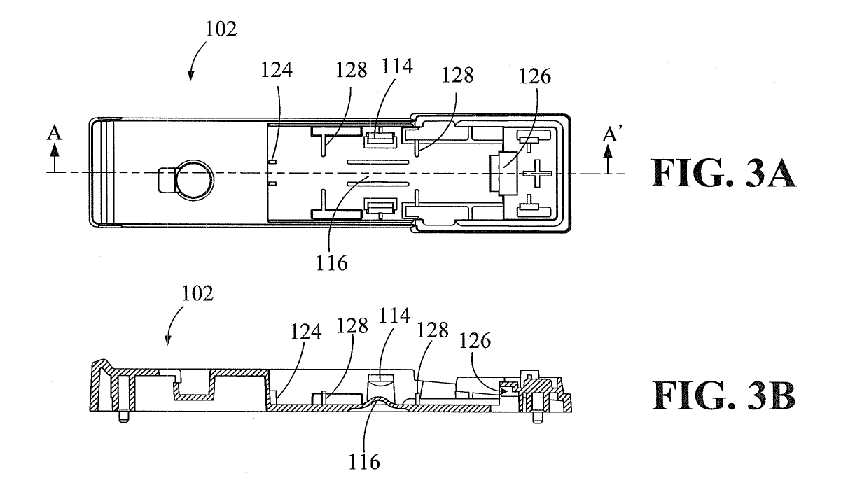

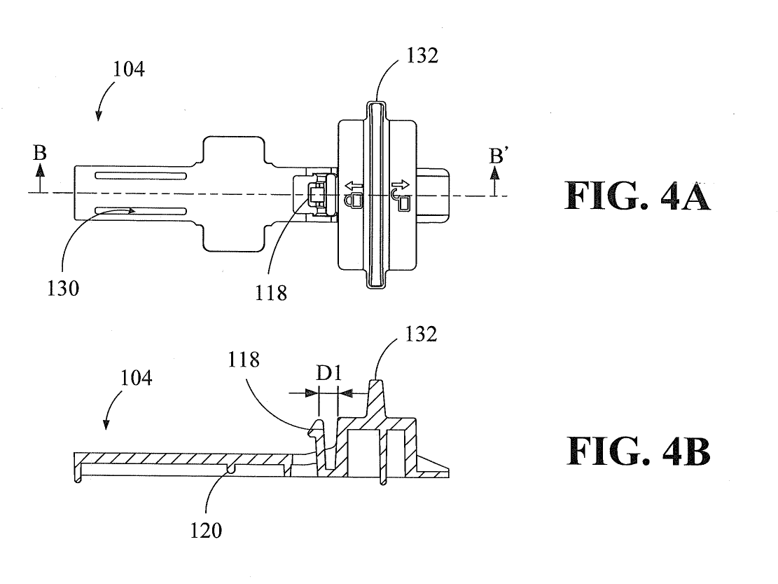

Please refer to FIG. 2 and FIGS. 3A-3B. FIG. 3A is a schematic view of the locking base 102 of the locked warning apparatus 100 shown in FIG. 2 according to one embodiment of the present invention. FIG. 3B is a schematic cross-sectional view of the locking base 102 along the section-line A-A′ as shown in FIG. 3A according to one embodiment of the present invention. The locking base 102 includes a clasping portion 114, an elastic protrusion 116, a withstanding portion 124, an embedding recess 126, and a guiding portion 128. Please refer to FIG. 2 and FIGS. 4A-4B. FIG. 4A is schematic view of the locking device 104 of the locked warning apparatus 100 according to one embodiment of the present invention. FIG. 4B is schematic cross-sectional view of the locking device 104 along the section-line B-B′ as shown in FIG. 4A according to one embodiment of the present invention. The locking device 104 has a first buckling unit 118, a blocking portion 120, at least one slot 130, and a force exertion 132.

When the locking device 104 moves on the locking base 102, the clasping portion 114 of the locking base 102 contacts the locking device 104 for positioning the locking device 104 and the clasping portion 114 reciprocates a back and forth motion on the elastic protrusion 116 of the locking base 102 to allow the locking device 104 to retain either a lock status or an unlock (i.e. release) status correspondingly. That is, when the blocking portion 120 of the locking device 104 is pushed or impelled, the blocking portion 120 represses down the elastic protrusion 116 so that the lock status and the unlock status are defined by of the front and rear portions of the elastic protrusion 116. Specifically, the locking device 104 retains the lock status if the blocking portion 120 is positioned in the front portion of the elastic protrusion 116 which is corresponding to the withstanding portion 124, and the locking device 104 retains the unlock status if the blocking portion 120 is positioned in the rear portion of the elastic protrusion 116 which is corresponding to the embedding recess portion 126. For example, the elastic protrusion 116 is a hump on the bottom of the locking base 102. In one embodiment, the locking base 102 utilizes the clasping portion 114 in the left and right sides for slightly clasping the locking device 104 to the locking base 102 for smoothly moving the locking device 104. In one preferred embodiment of the present invention, the clasping portion 114 of the locking base 102 has an arc structure, e.g. semi-circular structure, and the arc structure with a line type contacts the locking device 104 with a surface type in a form of line-surface interface between the arc structure and the locking device 104. Since the contact between the arc structure and the locking device 104 is line-surface interface, the friction force between the locking base 102 and the locking device 104 is considerably reduced for easily sliding the locking device 104.

Specifically, when the locking device 104 retains the lock status, the locking device 104 withstands against the withstanding portion 124 of the locking base 102. When the locking device retains the unlock status, the locking device 104 withstands against the embedding recess portion 126. The locking device 104 guides the movement of the guiding portion 128 when the locking device 104 is changed either from the lock status to the unlock status or from the unlock status to the lock status. The withstanding portion 124 and the embedding recess portion 126 are used to limit the movement distance of the locking device 104 so that the locking device 104 retains either the lock status or unlock status based on the elastic protrusion 116. Further, when the locking device 104 slides on the locking base 102, the locking device utilizes at least one slot 130 to elastically contact the guiding portion 128 of the locking base 102 so that the guiding portion 128 guides the movement of the locking device 104. In other words, the size of the slot 130 elastically shrinks along the direction perpendicular to the section-line B-B′ so that the guiding portion 128 smoothly guides the locking device 104 along the direction of the section-line B-B′. In one preferred embodiment, the bottom of the locking device 104 with a line type contacts the locking base 102 with a surface type in a form of line-surface interface between the bottom and the locking base 102. For example, the bottom of the locking device 104 is composed of sidewalls, and the thickness ends of the sidewalls contact the locking base 102 to form the line-surface interface. In one embodiment, a plastic injection mold is used to form the sidewalls of the locking device 104. The friction force between the locking base 102 and the locking device 104 is considerably reduced and the lubricant between the thickness ends of the sidewalls of the locking device 104 can be saved to increase the precision, the smooth and the life span of the locked warning apparatus 100 for easily sliding the locking device 104.

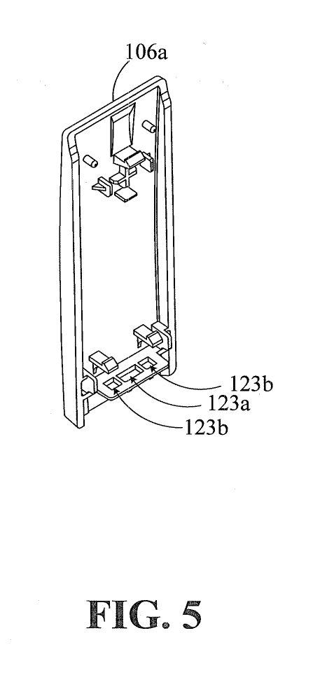

Please refer to FIG. 2 and FIG. 5. FIG. 5 is a schematic view of the upper cover assembly 106 of the locked warning apparatus 100 according to one embodiment of the present invention. The upper cover assembly 106 pivotally connected to the locking base 102 has a first buckling hole 123a and a second buckling hole 123b. The first buckling unit 118 of the locking device 104 is fastened to the first buckling hole 123a of the upper cover assembly 106 when the locking device 104 retains the lock status. The pressing unit 108 pivotally connected to the locking base 102 has a second buckling unit 122 wherein the second buckling unit 122 is fastened to the second buckling hole 123b of the upper cover assembly 106 and the second buckling unit 122 is disengaged from the second buckling hole 123b by pushing the pressing unit 108 for ejecting the upper cover assembly 106 from the locking base 102 when the locking device 104 retains the unlock status.

Please refer to FIG. 2, FIG. 3A-3B, FIGS. 4A-4B, and FIG. 5. The locked warning apparatus 100 utilizes the locking device 104 reciprocates a back and forth motion (i.e. upward and downward) on the locking base 102 so that the locking device 104 and the pressing unit 108 is capable of either buckling the upper cover assembly 106 to the locking base 102 or ejecting the upper cover assembly 106 from the locking base 102 by pushing the pressing unit 108 when the upper cover assembly 106 is released from the locking device 104. In one case, when the upper cover assembly 106 retains the lock status by impelling upward the locking device 104, the upper cover assembly 106 does not pop up even if the user pushes the pressing unit 108. In the other case, when the upper cover assembly 106 retains the unlock (released) status by impelling downward the locking device 104, the upper cover assembly 106 pops up by the force of the spring 109a after the user pushes the pressing unit 108.

The locking device 104 reciprocates a back and forth motion by impelling the force exertion 132 and a predetermined distance D1 is disposed between the force exertion 132 and the first buckling unit 118 of the locking device 104. The first buckling unit 118 has flexibility along the predetermined distance to be stably fastened to the upper cover assembly 106 when the upper cover assembly 106 is buckled to the locking device 104, i.e. the lock status. Specifically, the locking device 104 employs the first buckling unit 118 with the flexibility (bending toward the force exertion 132) to hook up the upper cover assembly 106 so that the locking device 104 can stably fastens the upper cover assembly 106 for preventing the locking device 104 from the release status due to backward compression while the upper cover assembly 106 is pressed and buckled to the locking device 104 for retaining the lock status of the locking device 104.

In the present invention, since the locking device 104 retains either the lock status or the unlock status and the upper cover assembly 106 is not ejected from the locking base 102, the locked warning apparatus 100 can warn against or prohibit the unauthorized users from removing the hard disk drive bracket 110 to avoid the damage of the hard disk drive or data lost during the access (e.g. read/write) procedure of the hard disk drive. The locked warning apparatus 100 replaces the conventional set of lock and key to solve the problem key lost when the user cannot find the key to unlock the lock. That is, the locking device 104 has the feature of reciprocating a back and forth motion to generate the lock and unlock status to improve the conventional set of lock and key to omit the use of an additional unlock tool for reducing the manufacturing cost.

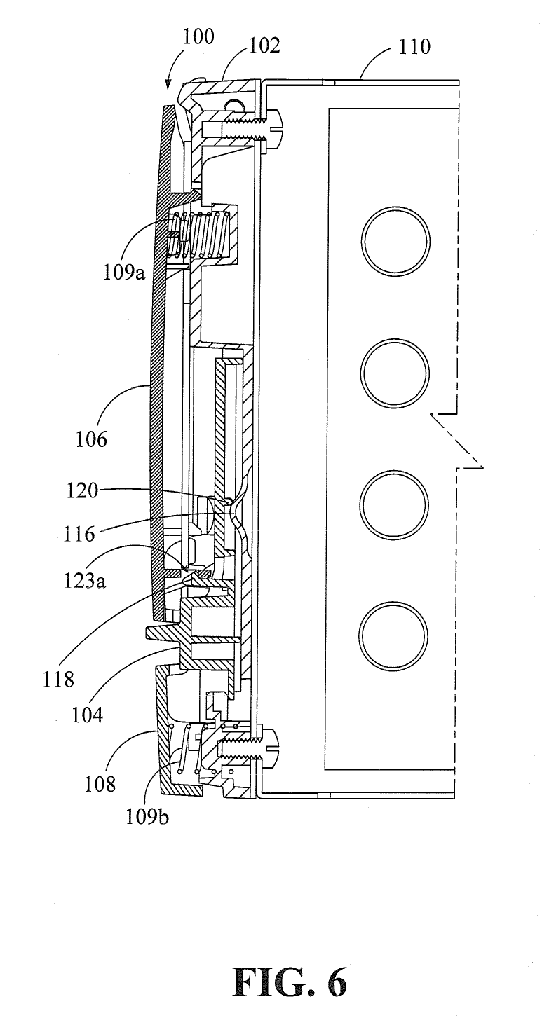

Please refer to FIG. 2, FIG. 5 and FIG. 6. FIG. 6 is a partially schematic cross-sectional view of the locked warning apparatus 100 retaining a lock status according to one embodiment of the present invention. When the locking device 104 retains the lock status, the first buckling unit 118 of the locking device 104 is fastened to the first buckling hole 123a of the upper cover assembly 106 and the second buckling unit 122 of the pressing unit 108 is temporarily fastened to the second buckling hole 123b so that the upper cover assembly 106 is secured to the locking base 102. That is, the upper cover assembly 106 is covered with the locking base 102.

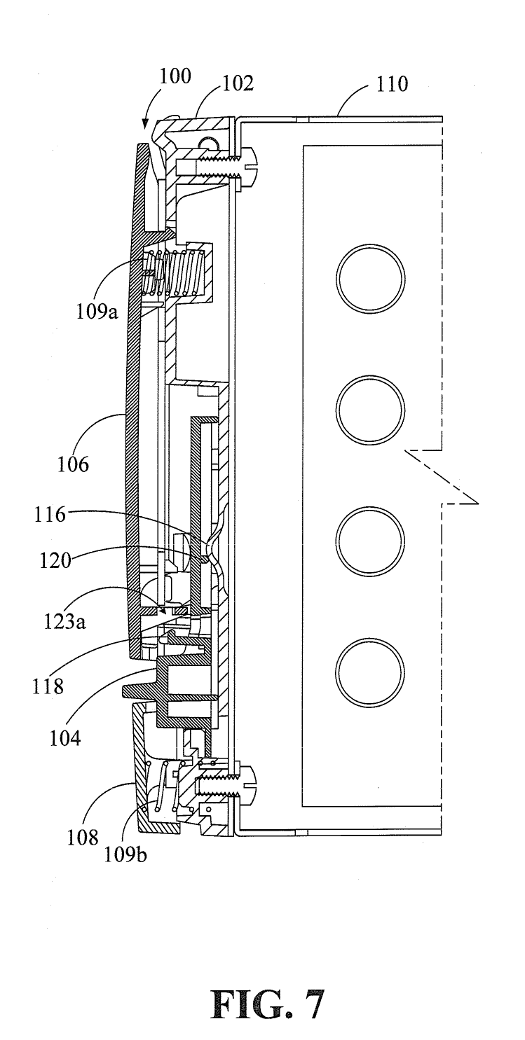

Please refer to FIG. 2, FIG. 5 and FIG. 7. FIG. 7 is a partially schematic cross-sectional view of the locked warning apparatus 100 retaining an unlock status according to one embodiment of the present invention. When the locking device 104 retains the unlock status, the first buckling unit 118 of the locking device 104 is disengaged from the first buckling hole 123a of the upper cover assembly 106 and the second buckling unit 122 of the pressing unit 108 is fastened to the second buckling hole 123b so that the upper cover assembly 106 is secured to the locking base 102. That is, when the upper cover assembly 106 is covered with the locking base 102 and the lock device 104 does not buckle the upper cover assembly 106, the upper cover assembly 106 is ejected by pushing the pressing unit 108 if the pressing unit 108 is temporarily buckled to the upper cover assembly 106 and the locking device 104 retains the unlock status.

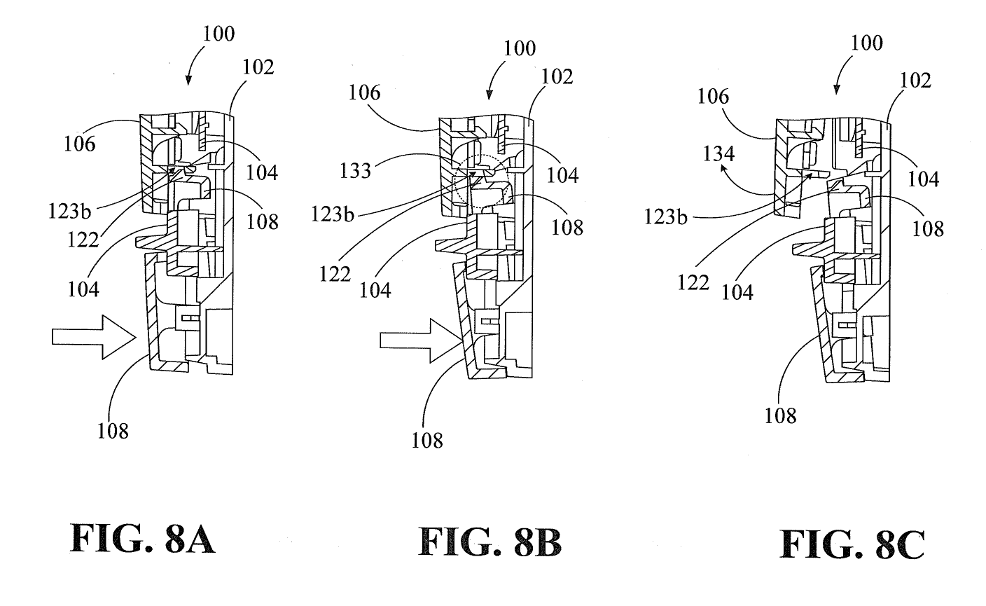

Please refer to FIG. 2 and FIGS. 8A-8C. FIGS. 8A-8C are partially schematic cross-sectional views of the upper cover assembly 106 disengaging from the pressing unit 108 by pushing the pressing unit 108 for ejecting the upper cover assembly 106 from the locking base 102 according to one embodiment of the present invention. First, the first buckling unit 118 of the locking device 104 is disengaged from the first buckling hole 123a of the upper cover assembly 106 (as shown in FIG. 7) when the locking device 104 is in the unlock status. Meanwhile, the second buckling unit 122 is fasten to the second buckling hole 123b of the upper cover assembly 106, as shown in FIG. 8A. Second, the upper cover assembly 106 is gradually released from the locking base when the second buckling unit 122 of the pressing unit 108 is gradually disengaged from the second buckling hole 123b of the upper cover assembly 106 by pushing the pressing unit 108, as shown in circular dashed-line 133 of FIG. 8B. Finally, the upper cover assembly 106 is totally ejected from the locking base when the second buckling unit 122 of the pressing unit 108 is totally disengaged from the second buckling hole 123b of the upper cover assembly 106 after pushing the pressing unit 108, as shown in arrow indication 134 of FIG. 8C.

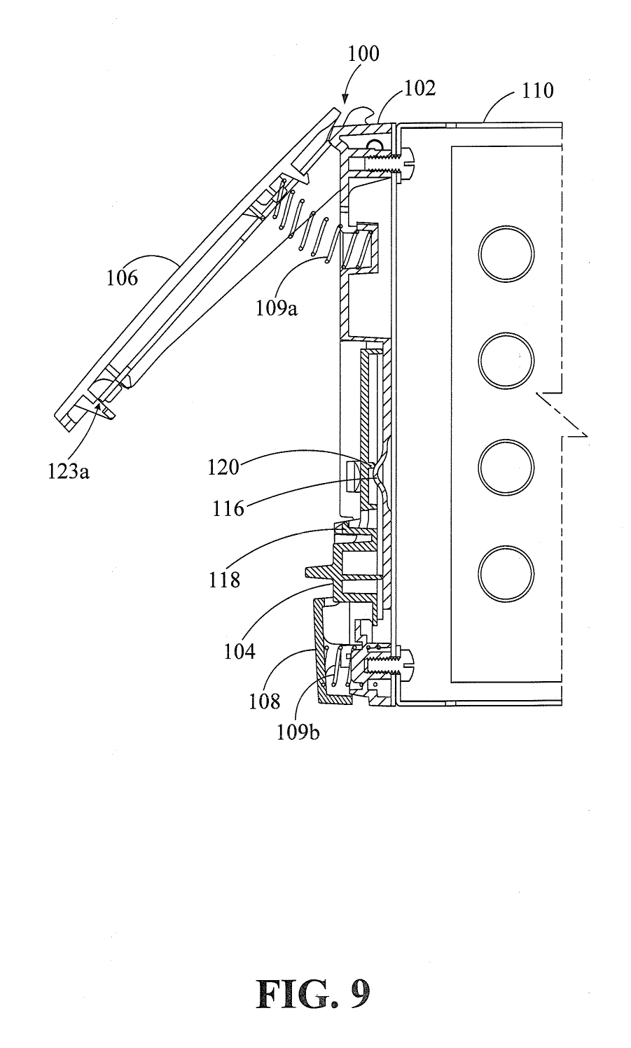

Please refer to FIG. 2 and FIG. 9. FIG. 9 is partially schematic cross-sectional view of the locking device 104 retaining the lock status while the upper cover assembly 106 is ejected from the locking base 102 according to one embodiment of the present invention. The first buckling unit 118 of the locking device 104 is disengaged from the first buckling hole 123a of the upper cover assembly when the locking device 104 is in the lock status. After the upper cover assembly 106 ejects from the locking base 102, the upper cover assembly 106 is re-secured to the locking base again 102 by pushing the upper cover assembly 106 to approach the locking base 102. That is, the upper cover assembly 106 is covered with the locking base 102 again.

According to the above-mentioned descriptions in FIG. 6 and FIG. 9, when the locking device 104 retains the lock status, the locking device 104 buckles the upper cover assembly 106. Thus, even if the pressing unit 108 is pressed down, the upper cover assembly 106 cannot pop up from the locking base 102, as shown in FIG. 6. However, when the upper cover assembly 106 pops up shown in FIG. 9, the user can push the upper cover assembly 106 so that the locking device 104 stably is capable of buckling the upper cover assembly 106 regardless of the lock or unlock status of the locking device 104. The locking device 104 employs the first buckling unit 118 with the flexibility to hook up the upper cover assembly 106 so that the locking device 104 can stably fastens the upper cover assembly 106 for preventing the locking device 104 from the release status due to backward compression while the upper cover assembly 106 is pressed and buckled to the locking device 104 for retaining the lock status of the locking device 104.

The locked warning apparatus 100 in the present invention can warn against or prohibit the unauthorized users from removing the hard disk drive bracket 110 to avoid damage of the hard disk drive or data lost during the access (e.g. read/write) procedure of the hard disk drive. The locked warning apparatus 100 replaces the conventional set of lock and key to solve the problem key lost when the user cannot find the key to unlock the lock.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A locked warning apparatus used in a handle of a hard disk drive bracket, the locked warning apparatus comprising:
a locking base having a clasping portion and an elastic protrusion;
a locking device having a first buckling unit and a blocking portion, wherein when the locking device moves on the locking base, the clasping portion of the locking base contacts the locking device and the blocking portion reciprocates a back and forth motion on the elastic protrusion of the locking base to allow the locking device to retain either a lock status or an unlock status correspondingly;
an upper cover assembly, pivotally connected to the locking base and having a first buckling hole and a second buckling hole, wherein the first buckling unit is fastened to the first buckling hole of the upper cover assembly when the locking device retains the lock status; and
a pressing unit, pivotally connected to the locking base and having a second buckling unit, wherein the second buckling unit is fastened to the second buckling hole of the upper cover assembly, and the second buckling unit is disengaged from the second buckling hole by pushing the pressing unit for ejecting the upper cover assembly from the locking base when the locking device retains the unlock status.

2. The locked warning apparatus of claim 1, wherein the locking base further comprises a withstanding portion to allow the locking device to withstand against the withstanding portion when the locking device retains the lock status.

3. The locked warning apparatus of claim 1, wherein the locking base further comprises an embedding recess to allow the locking device to withstand against the embedding recess when the locking device retains the unlock status.

4. The locked warning apparatus of claim 1, wherein the locking base further comprises a guiding portion to allow the locking device to guide the movement of the guiding portion when the locking device is changed either from the lock status to the unlock status or from the unlock status to the lock status.

5. The locked warning apparatus of claim 4, wherein the locking device further comprises at least one slot to allow the guiding portion to elastically contact the locking device for guiding the movement of the locking device.

6. The locked warning apparatus of claim 1, wherein the locking device further comprises a force exertion and a predetermined distance is disposed between the force exertion and the first buckling unit of the locking device, and wherein the first buckling unit has flexibility along the predetermined distance to be stably fastened to the upper cover assembly when the upper cover assembly is buckled to the locking device.

7. The locked warning apparatus of claim 1, wherein the clasping portion of the locking base has an arc structure and the arc structure with a line type contacts the locking device with a surface type.

8. The locked warning apparatus of claim 1, wherein the bottom of the locking device with a line type contacts the locking base with a surface type.

9. The locked warning apparatus of claim 1, wherein the first buckling unit is fastened to the first buckling hole of the upper cover assembly when the locking device is in the lock status, and the upper cover assembly is secured to the locking base when the second buckling unit of the pressing unit is temporarily fastened to the second buckling hole of the upper cover assembly.

10. The locked warning apparatus of claim 1, wherein the first buckling unit is disengaged from the first buckling hole of the upper cover assembly when the locking device is in the unlock status, and the upper cover assembly is secured to the locking base when the second buckling unit of the pressing unit is temporarily fastened to the second buckling hole of the upper cover assembly.

11. The locked warning apparatus of claim 1, wherein the first buckling unit is disengaged from the first buckling hole of the upper cover assembly when the locking device is in the unlock status, and the upper cover assembly is ejected from the locking base when the second buckling unit of the pressing unit is disengaged from the second buckling hole of the upper cover assembly by pushing the pressing unit.

12. The locked warning apparatus of claim 1, wherein the first buckling unit is disengaged from the first buckling hole of the upper cover assembly when the locking device is in the lock status, and after the upper cover assembly ejects from the locking base, the upper cover assembly is secured to the locking base by pushing the upper cover assembly to approach the locking base.
